(19) United States
(12) Patent Application Publication
(10) Pub. No.: US 2016/0323144 A1
(43) Pub. Date: Nov. 3, 2016

(54) TRAFFIC-DRIVEN NETWORK CONTROLLER PLACEMENT IN SOFTWARE-DEFINED NETWORKS

(71) Applicant: Futurewei Technologies, Inc., Plano, TX (US)

(72) Inventors: Min LUO, Cumming, GA (US); Shih-Chun LIN, Alpharetta, GA (US); Ian F. AKYILDIZ, Alpharetta, GA (US)

(73) Assignee: Futurewei Technologies, Inc., Plano, TX (US)

(21) Appl. No.: 15/141,367

(22) Filed: Apr. 28, 2016

Related U.S. Application Data
(60) Provisional application No. 62/154,566, filed on Apr. 29, 2015.

(51) Int. Cl. H04L 12/24; H04L 29/08

(52) U.S. Cl. CPC H04L 41/0816; H04L 41/5054; H04L 67/16

(57) ABSTRACT

A method and an apparatus that allocate controllers in an SDN are described. The SDN may comprise a plurality of switches, each switch having a selection likelihood and one or more assignment likelihoods. Possible values of the selection likelihood and the assignment likelihoods of each switch may be identified subject to allocation constraint imposed on one or more controllers of the SDN. A set of values from the possible values of the selection likelihood and the assignment likelihoods of each switch can be selected. The set of values selected can be rounded to integer values respectively. And the controllers of the SDN can be allocated based on the integer values.

### CROSS-REFERENCE TO RELATED APPLICATIONS

The present application claims priority to U.S. Non-Provisional Patent Application No. 62/154,566 filed Apr. 29, 2015 by Min Luo et al. and titled “Traffic-Driven and Capacity Constraint Network Controller Placement in Software-Defined Networks,” which is incorporated by reference herein in its entirety.

### BACKGROUND

Software-Defined Network (SDN) is an emerging architecture that is dynamic, manageable, cost-effective, and adaptable, making it ideal for the high-bandwidth, dynamic nature of applications. This architecture decouples the network control and forwarding functions enabling the network control to become directly programmable and the underlying infrastructure to be abstracted for applications and network services. In the SDN, network control is directly programmable because it is decoupled from forwarding functions. Abstracting control from forwarding in the SDN lets administrators dynamically adjust network-wide traffic flow to meet changing needs. Network intelligence in the SDN is logically centralized in software-based SDN controllers that maintain a global view of the network, which appears to applications and policy engines as a single, logical switch. The SDN lets network managers configure, manage, secure, and optimize network resources very quickly via dynamic, automated SDN programs, which they can write themselves because the programs do not depend on proprietary software.

### SUMMARY

In one embodiment, the disclosure includes a method for network configuration. The method comprises providing representation of a software defined network (SDN) comprising a plurality of switches located in separate locations, wherein each switch has a selection likelihood and one or more assignment likelihoods, the selection likelihood to indicate how likely a controller is located with the switch, each assignment likelihood of the switch to indicate how likely a separate one of the switches is assigned to a controller located with the switch; identifying possible values of the selection likelihood and the assignment likelihoods of each switch subject to allocation constraint imposed on one or more controllers of the SDN; comparing values of an objective measure of the switches among the possible values of the selection likelihood, wherein the objective measure indicates number of the controllers for the SDN; selecting, based on the comparison, a set of values from the possible values of the selection likelihood and the assignment likelihoods of each switch; rounding the set of values selected to integer values respectively in a randomized rounding manner, wherein the integer values indicate where each controller is located among the separate locations, and wherein the integer values indicate which of the controllers each switch is assigned to; and allocating, based on the integer values, the controllers in the SDN.

In one embodiment, the disclosure includes a placement server, comprising: transceiver units; a processor; and a memory coupled to the processor, wherein the memory comprises instructions. When implemented by the processor, the instructions may cause the server to identify possible values of selection likelihood and assignment likelihoods of each switch in a software defined network (SDN) subject to allocation constraint imposed on one or more controllers of the SDN, where each switch has a selection likelihood and one or more assignment likelihoods, the selection likelihood to indicate how likely a controller is located with the switch, each assignment likelihood of the switch to indicate how likely a separate one of the switches is assigned to a controller located with the switch; compare values of an objective measure of the switches among the possible values of the selection likelihood, wherein the objective measure indicates number of the controllers for the SDN; select, based on the comparison, a set of values from the possible values of the selection likelihood and the assignment likelihoods of each switch; round the set of values selected to integer values respectively in a randomized rounding manner, wherein the integer values indicate where each controller is located among the separate locations, and wherein the integer values indicate which of the controllers each switch is assigned to; and allocate, based on the integer values, the controllers in the SDN.

In one embodiment, the disclosure includes a non-transitory computer-readable medium, storing instructions. When the instructions are executed by a processor, the instructions cause the processor to identify possible values of selection likelihood and assignment likelihoods of each switch in a software defined network (SDN) subject to allocation constraint imposed on one or more controllers of the SDN, where each switch has a selection likelihood and one or more assignment likelihoods, the selection likelihood to indicate how likely a controller is located with the switch, each assignment likelihood of the switch to indicate how likely a separate one of the switches is assigned to a controller located with the switch; compare values of an objective measure of the switches among the possible values of the selection likelihood, wherein the objective measure indicates number of the controllers for the SDN; select, based on the comparison, a set of values from the possible values of the selection likelihood and the assignment likelihoods of each switch; round the set of values selected to integer values respectively in a randomized rounding manner, wherein the integer values indicate where each controller is located among the separate locations, and wherein the integer values indicate which of the controllers each switch is assigned to; and allocate, based on the integer values, the controllers in the SDN.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1A is a block diagram illustrating an example of a software defined network;

FIG. 1B is a graph diagram illustrating a model representing traffic flows of a software defined network;

FIG. 1C is a block diagram illustrating a system for network controller placement according to one embodiment of the present invention;

FIG. 2 illustrates a flow chart showing a process of generating a jointly optimized controller placement framework of an embodiment;

FIG. 3 illustrates a flowchart showing a process for fast optimization of an embodiment;

FIG. 3A illustrates a flowchart showing a controller placement process of an embodiment;

FIG. 4 illustrates a schematic diagram of a network element for determining optimal controller placement of an embodiment.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein are various embodiments for a framework of network controller placement. The framework can achieve substantially optimal network planning, good load balancing, and efficient link utilization. Traffic-driven design is important to provide optimal controller placement in software-defined networks. Further, traffic-driven designs provide good planning for out-band and necessary design for in-band SDNs. A method is provided that jointly considers controller placement and control traffic engineering for the multiple controllers. An efficient and effective approximation algorithm is employed to achieve good solution as compared with the optimal one within a few iterations. A linear-fast convergent algorithm is employed to achieve optimal solution within a few iterations and to provide a sub-optimal solution for each of the iterations for real-time application. Due to computational efficiency and low time complexities, various embodiments may be applied to generic large-scale SDNs with different traffic statistics.

Software-defined networks (SDNs) decouple network forwarding infrastructure from the supporting management applications to provide high flexibility for better network architecture planning. The global information visibility of SDNs, such as real-time network and traffic states, facilitates new control traffic engineering, which is particularly crucial for in-band SDNs. The framework of this application for network controllers can address the joint consideration of network planning with control traffic balancing, which serves as the prerequisite of on-line and adaptive data traffic engineering in SDNs. For in-band SDNs, control messages are greatly affected by the existing data traffic and the link serving capacity, and thus such a joint consideration is important. For out-band SDNs. The framework of this application can provide network architecture planning for out-band SDNs with extra control channels dedicated for control messages. Out-band SDNs may serve as a special case of In-band modes.

In addition to “pure” facility allocation that considers the optimal network planning for the minimum required facilities, the framework of this application can take into account the impact on the traffic performance from the given allocation. Further, the framework of this application can be adapted to balance and forward data traffic in data plane as well as the in-band control traffic. Existing. The framework of this application can also determine an optimal (or substantially optimal) multi-controller placement together with determining a minimum (or substantially minimum) required number of controllers, controller locations, and control domain assignments.

In some embodiments, the framework of this application can identify the optimal forwarding paths between switches and controllers to minimize the average (or maximum) delay of control traffic. Considerations of the delays of control traffic may have a higher priority than the delays of data traffic in controller placement. The framework of this application can be applicable for a single-controller network, a multiple-controller network or other applicable network configurations. The framework of this application can support network planning jointly considering the topological resource allocation and the traffic performance through the information of global network states and dynamic traffic statics.

In an embodiment, a controller (e.g., an SDN controller) may be configured to generate the framework that jointly considers the controller placement with traffic performance. Multiple-controller placements with respect to controller serving capacity and localized control domain may be considered concurrently with the impact of control traffic from data traffic and link serving capability. The controller provides a framework that allows reliable controller placement, allows real-time control traffic transmission, allows fast re-routing of control traffic, serves as the foundation for designing traffic-driven controller architecture, and provides the performance benchmark for any other control polices afterwards.

For example, the framework may provide high transmission quality by minimizing the queuing latency of control traffic regarding in-band transmissions with existing data flows. Additionally, the framework may be highly scalable by providing fast, and possibly parallel, computations to ensure low complexity for practical large system implementation. The framework may be robust and achieves consistent good performance under a variety of traffic scenarios and different network topologies via traffic statistics driven designs. The framework may be easily implemented in centrally controlled SDN. For optimal multiple-controller placement an approximation algorithm with provable performance bounds is provided. For optimal control traffic forwarding with large network size and vast decision space a fast and parallel algorithm is also provided.

The framework applies a queuing network model and traffic statistics to the joint optimized traffic-driven controller placement problem. For example, an approximated randomized rounding method is used to decide the placement of multiple controllers based on queuing network model and Markovian traffic statistics. An efficient transmission methodology and real-time re-routing of control traffic are then applied to yield the fast convergence to the optimal solution by employing the Alternating Direction Method of Multipliers (ADMM) with respect to multiple controllers.

A non-linear multi-objective optimization is formulated to minimize the required number of controllers and/or to minimize the average (or maximum) network delay. The non-linear multi-objective optimization may have topology constraints, capacity constraints, and traffic constraints. Examples of constraints may include, but are not limited to, localized domain assignment requirements, a dedicated controller to each switch, controller serving capacity constraints, flow conservation (possible automatic route selection), link serving capacity constraints, and bandwidth guarantees of data traffic.

A non-linear multi-objective (mixed integer and continuous) optimization framework is included to find the optimal controller placement and optimal control traffic forwarding among links at the same time. A randomized rounding approximation algorithm is provided to obtain a feasible assignment solution for controller locations. In an embodiment, the expected number of iterations is at most 2 for a “good” solution. A polynomial-time algorithm is provided to yield optimal solutions with pre-specified accuracy for control traffic forwarding. For example, the polynomial-time algorithm is a fast convergent algorithm O(1/c^{m}) of primal-dual rules that is enforced to enable fast transmission and real-time re-routing of control traffic. The randomized rounding approximation algorithm and the polynomial-time algorithm can be implemented iteratively to provide adaptive control for continuous system performance improvement.

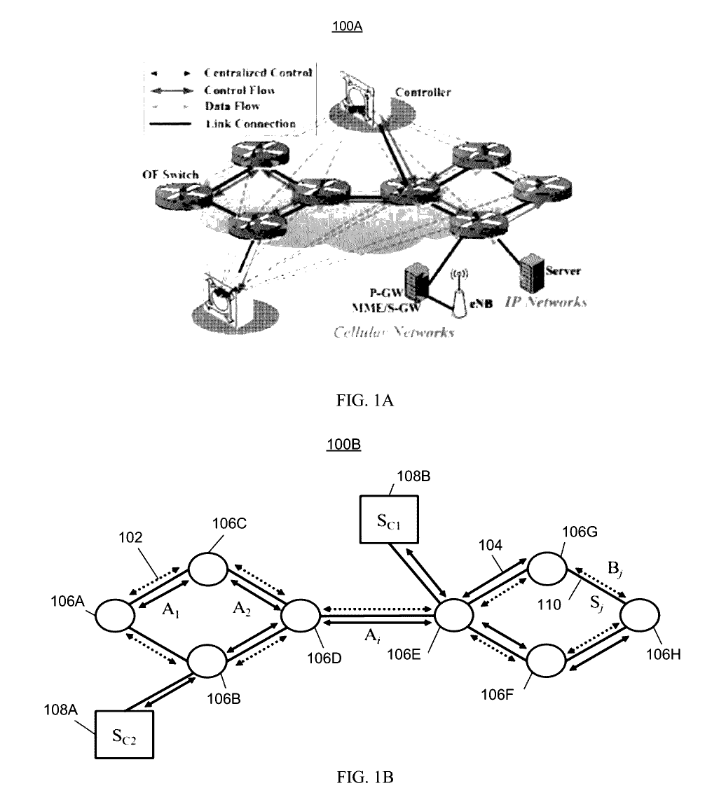

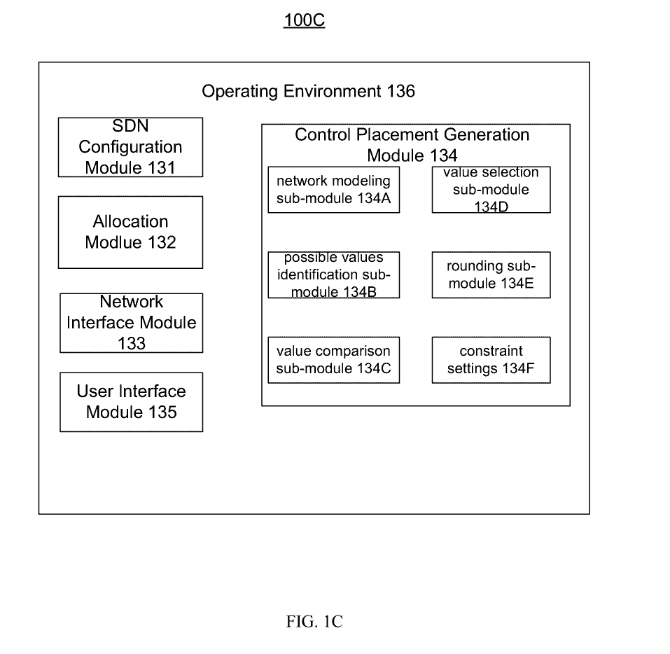

FIG. 1A is a block diagram illustrating an example of a software development network (SDN). In an SDN, switches, such as Openflow (OF) switches, forward the traffic from a variety of networks. The variety of networks may include IP data networks and cellular networks. In an example when a new data flow is generated, a responsible switch may send a routing request (control message) to an assigned SDN controller, to which the switch is assigned. Once the controller receives the control message, it may calculate one or more optimal routing paths to destination switch of the data flow and set up routing tables of switches along the one or more optimal paths. The effectiveness and scalability of SDNs may highly depend on the timely delivery of control messages from OF-switches to multiple controllers. Optimal controller placement and control traffic balancing with regard to control and data traffic statistics may increase the effectiveness and scalability of SDNs

Two approaches may develop control channels: dedicated out-band control or in-band control. Dedicated out-band control may use a dedicated network to establish direct control links between each switch and its responsible controller. Such an approach is cost-prohibitive and not suitable for large-scale networks, such as metropolitan-area-networks that span a city. On the contrary, in-band control may allow control and data messages to share the same forwarding infrastructure and thus is more cost-efficient. Therefore, in-band control may be preferred in some embodiments.

FIG. 1B is a graph diagram illustrating a model representing traffic flows of a software defined network, such as network 100A of FIG. 1A.

For example, network 100B may include a graph G=(V, J) representing a network, such as an SDN or a queuing network. V may denote the set of OF-switches with total n switches (i.e., |V|=n) and J may denote the set of links with total |J| links. A controller can be placed at any location among all OF-switches. The set of SDN controllers can be denoted as K⊂V with a total of C controllers, and the serving time capability of the kth controller can be modeled as an exponential distribution with a mean time value 1/μ_{C}^{k}, ∀kεK.

Network 100B may be based on a representation generated by an SDN controller. In one embodiment, network 100B includes one or more controllers, such as controllers 108A and 108B and comprises a plurality of switches, such as switches 106A-106H. The controllers 108 and the switches 106 are interconnected using links (e.g., physical links or virtual links) and/or tunnels (e.g., multiprotocol label switching (MPLS) tunnels). Each link has a link capacity, which is shown as a solid line Sⱼ. Links 110 are configured to support, for example, control flows 102 and data flows 104. Control flows 102 are shown as dashed arrowed lines Bⱼ. Data flows 204 are shown as solid arrowed lines Aᵢ. Network 100B may be configured as shown or in any other suitable configuration. Network 100B may be the queuing network system in the embodiments associated with FIG. 1B.

In one embodiment, regenerative stochastic processes for generic traffic models that generalize Internet traffic models can include alternating renewal processes, recurrent Markov chains, and reflected Brownian motion. Without loss of generality, both control and data flows may be modeled by regenerative processes. In particular, the control traffic of each switch i is modeled by a regenerative arrival process Aᵢ a mean value σᵢ. For the jth link and jεJ, the existing data flow follows a regenerative arrival process Bⱼ with mean value and link serving time follows another regenerative process with mean time 1/μⱼ

FIG. 1C is a block diagram illustrating a system for network controller placement according to one embodiment of the present invention. In one embodiment, system 100C may include operating environment 136, such as an operating system for an SDN controller in FIG. 1B or other applicable control device or server, hosted by one or more processors. System 100C may also include SDN configuration module 131, allocation module 132, network interface module 133, controller placement generation module 134, user interface module 135 or other applicable modules to provide controller placement in a network, such as an SDN.

In one embodiment, SDN configuration module 131 may generate or receive requirement, specifications or configuration data of an SDN, such as quantity of switches, data forwarding speed, packet loss rate and so on. Allocation module 132 may allocate controllers based on controller placement result generated by or received from control placement generation module 134. Network interface module 133 may communicate data packets or control packets with other apparatus in the SDN and out of the SDN, such as an SDN switch, an SDN controller, a gateway, a base station or a router. Controller placement generation module 134 may generate a controller placement result for an SDN. The result may indicate how many controllers are needed, where the controllers are located, and/or which controller each switch should be assigned.

In one embodiment, allocation module 132 may deliver or transmit controller placement (or activation) and switch assignment instructions to targeted controller/switches according to a result of controller placement. For example, these instructions may dynamically activate/deactivate already installed controller devices/components collocated with switches to dynamically update controller placement/assignment for an SDN in real time. Alternatively or optionally, allocation module 132 may generate a user interface representation of the placement result to be presented, for example, via user interface module 135. A graphic user interface of the placement result may display (e.g. in a screen) topology of the SDN, amount of controllers to be allocated, the position of the controllers and some other applicable information.

Controller placement generation module 134 may a plurality of sub-modules. For example, network modeling sub-module 134A may provide representation of the SDN. In one embodiment, each switch has a selection likelihood and one or more assignment likelihoods in the representation of the SDN. The representation may allow formulation of the controller placement decisions as search/optimization operations based on an objective measure. For example, control placement generation module 134 may be configured with constraints settings 134F specifying required relationships among possible assignment/selection values for each switch.

The search/optimization operations may be performed by sub-modules of controller placement generation module 134. For example, possible values identification sub-module 134B can identify possible values of the selection likelihood and the assignment likelihoods of each switch subject to allocation constraint imposed on one or more controllers of the SDN. Constraint settings 134F can include requirements or constraints, such as allocation constraint or other applicable constraints, for determining controller placements. Value comparison sub-module 134C may compare values of an objective measure of the switches among the possible values of the selection likelihood. Value selection sub-module 134D may select, based on the comparison result of sub-module 134C, a set of values from the possible values of the selection likelihood and the assignment likelihoods of each switch.

Control placement generation module 134 may include rounding sub-module 134E to determine whether a controller should be located with a switch and which controller a switch should be assigned to, based on the result of search/optimization operations, by rounding the set of values selected to integer values respectively in a randomized rounding manner.

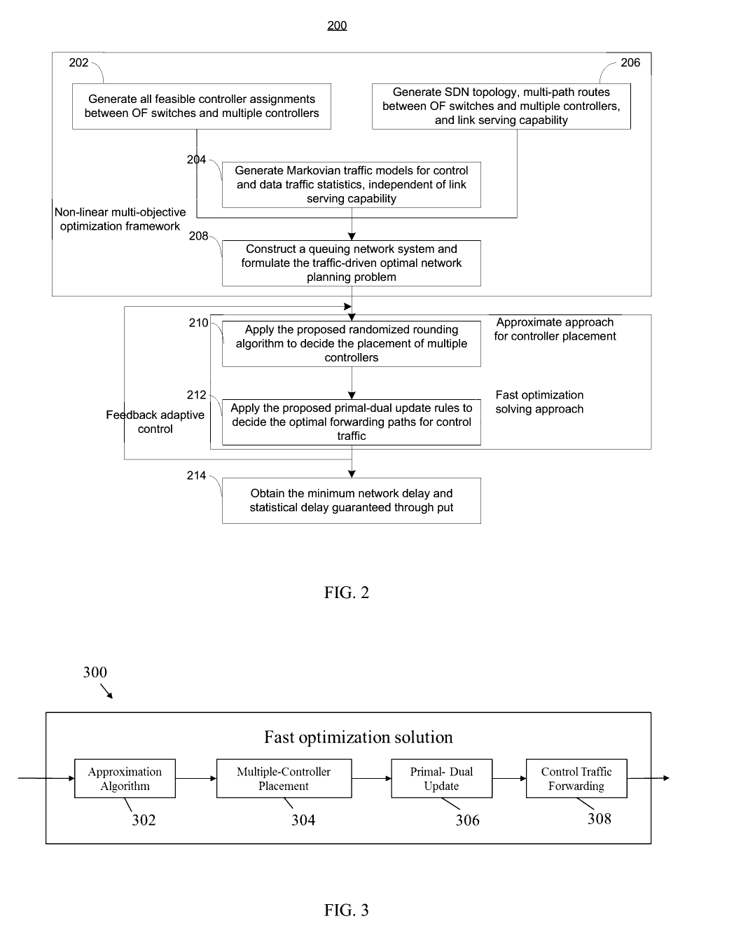

FIG. 2 is a flowchart illustrating an embodiment of a process to generate a jointly optimized controller placement framework. Exemplary process 200 may be performed by a processing logic that may include hardware, software or a combination of both. For example, process 200 may be performed by some components, such as network generation module 132 and controller placement generation module 134 of FIG. 1C. In one embodiment, process 200 may be implemented by an SDN controller to generate a framework for an SDN and to determine controller placement for the SDN. In steps 202-206, process 200 collects topological information and traffic statistics. At step 202, process 200 generates or obtains a plurality of feasible controller assignments between OF (Openflow) switches and multiple controllers. At step 204, process 200 generates or obtains traffic models for control and data traffic statistics, which may be independent of link serving capability. An example of a traffic model includes, but is not limited to, Markovian traffic models. At step 206, process 200 generates or obtains a SDN topology, multi-path routes between OF switches and multiple controllers, and link serving capabilities.

At step 208, process 200 constructs a queuing network system based on the collected topological information and traffic statistics. A queuing network system can be a data structure representing a network relationship, as illustrated in an exemplary queuing network system 100B. Process 200 also formulates a traffic-driven optimal network planning problem. A jointly optimized traffic-driven optimal controller placement problem may be based on the system model, placement indicators, and/or traffic matrices. At step 210, process 200 applies a randomized rounding approximation algorithm to decide the placement of multiple controllers. The SDN may obtain good plans for the minimum number of required controllers, decisions for the locations of the controllers, and controller domain assignments. At step 212, process 200 applies a primal-dual update rules to decide optimal forwarding paths for control traffic. For example, process 200 may apply fast and/or parallel algorithms to balancing the control traffic. Process 200 may also activate an adaptive feedback control for continuous system performance improvements. If the placement and routing policies generate a suitable solution, then the SDN controller returns to step 210; otherwise, the SDN controller proceeds to step 214. At step 214, process 200 obtains a minimum network delay and statistical delay guaranteed throughput.

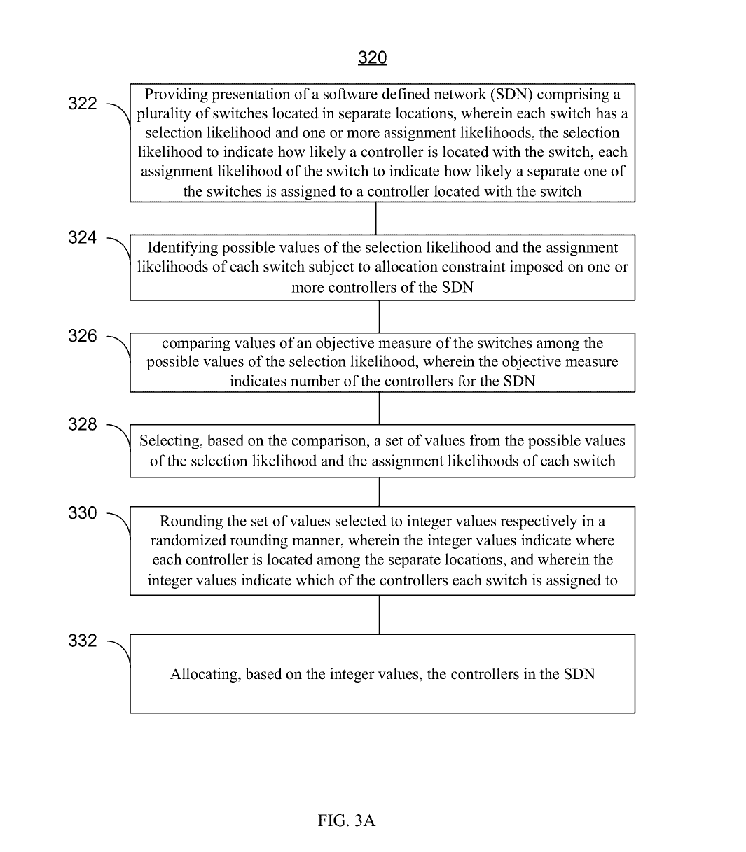

FIG. 3 is a flowchart illustrating an embodiment of a process for fast optimization. Exemplary process 300 may be performed by a processing logic that may include hardware, software or a combination of both. For example, process 300 may be performed by some components of system 100C of FIG. 1C. Process 300 may be implemented by a network node or a network controller to determine optimal controller placement and control traffic forwarding among a plurality of links at the same time. Steps 302 and 304 provide a reliable controller placement and steps 306 and 308 determine a fast and optimal forwarding of control traffic.

At step 302, process 300 may yield or generate a representation for a feasible placement solution based on a randomized rounding approximation algorithm. The randomized rounding approximation algorithm can be employed one or more times iteratively. The randomized rounding approximation algorithm is an approximation algorithm based on randomized rounding. The randomized rounding approximation algorithm provides fast convergence, for example, on average the randomized rounding approximation algorithm may yield a solution in two rounds. The randomized rounding approximation algorithm yields a solution of O(log n) OPT with high probability, where OPT is the optimal solution and n is the number of switches. Table 1 is an embodiment of a randomized rounding approximation algorithm.

At step 304, process 300 obtains a multiple-controller placement representation for maintaining controller serving capacity and localized control domain assignment.

TABLE 1
An embodiment of a randomized rounding approximation algorithm

| | |
|---|---|
| | Output: (C̅; y̅ₖ, z̅ᵢₖ) % Optimal controller placement |
| 1 | Solve LP_{MCP}. Let (yₖ′,zᵢₖ′) be the optimum solution. |
| 2 | z̅ᵢₖ ← 0, ∀i ∈ V, k ∈ V |
| 3 | while t ≦ log(n) + 2 do |
| 4 | \| z̅ᵢₖ ← 1 with probability p̅ᵢₖ = zᵢₖ′ |
| 5 | \| t ← t + 1 |
| 6 | end |
| 7 | repeat |
| 8 | \| line 3-6 |
| 9 | until Σ_{i∈V} σᵢzᵢₖIᵢₖ < μ_{C}^{k}, ∀ k ∈ V and C̅ ≦ αC′, |
| | where yₘₐₓ′ := max_{k∈V} yₖ ′ and α = log_{1/u}_{ₘₐₓ}′ 4C′; |

At step 306, process 300 updates the multiple-controller placement representation to generate optimal and sub-optimal placement solution via a fast iterative algorithm. The fast iterative algorithm can be employed one or more times iteratively and sub-optimal solutions can be obtained for each iteration. The fast iterative algorithm alternates between executing primal-dual update rules, for example, via Alternating Direction Method of Multiplier (ADMM). The fast iterative algorithm converges to optimal value within a few iterations and can be stopped at any time to get a solution for real-time applications. For example, primal-dual update rules converge to the optimal solutions with rate O(1/cm), where c>1 is a constant and m is the number of iterations. At step 308, process 300 obtains the optimal and sub-optimal forwarding route or forwarding path along which control traffic is forwarded for real-time applications.

FIG. 3A is a flowchart illustrating an embodiment of controller placement process. Exemplary process 320 may be performed by a processing logic that may include hardware, software or a combination of both. For example, process 320 may be performed by some components of system 100C of FIG. 1C. Process 320 may be implemented by a placement server to determine optimal controller placement for an SDN network. The placement server may or may not include an SDN controller. The placement server may be located in an SDN or remotely coupled with the SDN.

At step 322, process 320 can provide a software defined network (SDN), such as network 100A of FIG. 1A or network 100B of FIG. 1B. The SDN can comprise one or more switches located in separate physical locations (e.g. identified via longitude/latitude, cities, addresses, or other applicable location identifier). Each switch can have a selection likelihood and one or more assignment likelihoods. The selection likelihood of a switch can indicate how likely a controller is located at the same place or close by with the switch. Each assignment likelihood of the switch may indicate how likely a separate one of the switches is to be assigned to (or controlled by) a controller located with the switch.

For example, process 320 can provide an SDN, such as network 100A of FIG. 1A or network 100B of FIG. 1B. The SDN 100B comprises a plurality of switches 106 and one or more controllers 108. The switches 106 in the SDN may be located in separate locations. In other words, each switch 106 may have its own location which is different from location of any other switch 106. Each switch 106 in the SDN may have a selection likelihood and one or more assignment likelihoods. The selection likelihood may indicate how likely a controller 108 is located with the switch 106, each assignment likelihood of the switch 106 may indicate how likely a separate one of the switches 106 is assigned to a controller 108 located with the switch 106. For example, a selection likelihood of switch 106A may indicate how likely a controller 108 is assigned to the switch 106A; a selection likelihood of switch 106B may indicate how likelihood a controller 108 is assigned to the switch 106B, and so on.

In one example, when the switch 106 refers to switch 106A, assignment likelihoods of the switch 106 may include a likelihood of assigning switch 106B to a controller located with switch 106A, a likelihood of assigning switch 106C to the controller located with switch 106A, a likelihood of assigning switch 106D to the controller located with switch 106A, a likelihood of assigning switch 106E to the controller located with switch 106A, a likelihood of assigning switch 106F to the controller located with switch 106A, a likelihood of assigning switch 106G to the controller located with switch 106A and a likelihood of assigning switch 106H to the controller located with switch 106A. When the switch 106 refers to switch 106B, assignment likelihoods of the switch 106 may include a likelihood of assigning switch 106A to a controller located with switch 106B, a likelihood of assigning switch 106C to the controller located with switch 106B, a likelihood of assigning switch 106D to the controller located with switch 106B, a likelihood of assigning switch 106E to the controller located with switch 106B, a likelihood of assigning switch 106F to the controller located with switch 106B, a likelihood of assigning switch 106G to the controller located with switch 106B, a likelihood of assigning switch 106H to the controller located with switch 106B.

Step 322 may be performed by network modeling sub-module 134A.

At step 324, process 320 can identify possible values of the selection likelihood and the assignment likelihoods of each switch subject to one or more constraints in constraint settings 134F. For example, the constraints may include an allocation constraint imposed on one or more controllers of the SDN to limit, for example, distances among where these controllers are located, how the switches are to be assigned to the controllers etc. In one embodiment, the selection likelihood of a switch may be related to the assignment likelihoods of this switch. Thus, a possible value of the selection likelihood of the switch may be associated with possible values of the assignment likelihoods of the switch. A possible value may be a number no smaller than 0 and no bigger than 1.

In one embodiment, the allocation constraint in constraint settings 134F may indicate (or include) each or any combination of the following requirement (or constraint) 1 to requirement 4. For example, the allocation constraint may indicate requirement 1, requirement 2, requirement 3 or requirement 4. The allocation constraint may also indicate the combination of requirement 1 and requirement 2, the combination of requirement 2 and requirement 4 and the combination of requirement 1, requirement 3 and requirement 4, etc.

For example, referring to FIG. 1B, requirement 1 may indicate that each switch 206 may be assigned to no more than one controller 208 in network 100B. Requirement 1 may also indicate that each switch 206 in the network 100B may be assigned to one controller in the SDN and may not be assigned to any other controller. For example, switches 106A-106D may be assigned to controller 108A and may not be assigned to controller 108B, while switches 106E-H may be assigned to controller 108B and may not be assigned to controller 108A.

Requirement 2 may indicate that a distance between one of the switches (e.g. switch 106 of FIG. 1B) and one of the controllers (e.g. controller 108 of FIG. 1B) assigned to the one switch is no more than a preconfigured value. As an example, according to requirement 2, referring to FIG. 1B, when switch 106A is assigned to the controller 108A, a distance between the switch 106A and the controller 108A is no more than a preconfigured value. A distance between a switch 106 and a controller 108 may be number of hops between the switch 106 and the controller 108. For example, the distance between the switch 106A and the controller 108A is 2, the distance between the switch 106B and the controller 108A is 3, the distance between the switch 106G and 108A is 5.

Requirement 3 may indicate that an assignment likelihood of a switch may be no more than a selection likelihood of the switch. In a network including N switches, one switch may have N−1 assignment likelihoods. For example, in network 100B with 8 switches in FIG. 1B, switch 106A may have 7 assignment likelihoods. The 7 assignment likelihoods of switch 106A may include an assignment likelihood indicating how likely the switch 106B is assigned to a controller located with the switch 106A, an assignment likelihood indicating how likely the switch 106C is assigned to a controller (not illustrated in FIG. 1B) located with the switch 106A, an assignment likelihood indicating how likely the switch 106D is assigned to a controller located with the switch 106A, an assignment likelihood indicating how likely the switch 106E is assigned to a controller located with the switch 106A, an assignment likelihood indicating how likely the switch 106F is assigned to a controller located with the switch 106A, an assignment likelihood indicating how likely the switch 106G is assigned to a controller located with the switch 106A, and an assignment likelihood indicating how likely the switch 106H is assigned to a controller located with the switch 106A.

Selection likelihood of a switch 106 may indicate how likely a controller 108 is located with the switch 106 (e.g. located within the same data center with the switch). For example, selection likelihood of the switch 106A may indicate how likely a controller, such as the controller 108A, is located with the switch 106D. Selection likelihood of the switch 106A may indicate how likely a controller is located with the switch 106A. In one embodiment, each of assignment likelihoods of switch 106A, such as each of the 7 assignment likelihoods of switch 106A, may be of a value no more than the value of the selection likelihood of the switch 106A.

Requirement 4 may indicate that the amount of control traffic generated from the switches assigned to a controller (e.g. all the switches assigned to the controller) in a network should not exceed the processing capacity of the controller. In one example in FIG. 1B, when switches 106A-106D are assigned to the controller 108A, the amount of control traffic generated by all the switches 106A-106D may be within the processing capacity of the controller 108A. Subject to the above allocation constraint, a placement server based on process 320 may identify possible values of the selection likelihood and the assignment likelihoods of each switch 106.

In one embodiment, location of a controller may be represented by location of a switch with which the controller is located. For example, referring to FIG. 1B, controller 108A may be represented as a controller located with switch 106B. The location of controller 108A may also be represented as the location of switch 106B. When a controller is located with a switch, the controller may compute routing information, such as a routing table or a routing entry, merely based on control messages received from the switch. For example, the controller 108A may receive control messages from switch 106B and may not receive control messages from other switches. In another example, the controller 108A may receive control messages from switches other than switch 106B, but the controller 108A may not compute a routing table or a routing entry based on control messages received from switches other than switch 106B. If switch 106A is assigned to controller 108A, 106A may send control messages to switch 106B and then switch 106B may forward the control messages to controller 108A. If the last switch on the route of the control messages sent by switch 106A is not switch 106B, controller 108A may not compute routing information for switch 106A based on the control messages sent by switch 106A.

Switch i and switch k may be respectively used to represent a switch in an SDN, where i and k represent respectively any natural number no more than a pre-configured number V, may be expressed as iε and kεV, i and k are different from each other, and consequently switch i is independent from switch k. yₖ may represent whether a controller may be located with switch k or whether a controller may choose switch k's location. In one example, when a controller may be located with switch k, yₖ=1, and when a controller may not be located with switch k, yₖ=0. yₖ′ may be no smaller than 0 and no more than 1, representing selection likelihood of switch k. zᵢₖ may represent whether switch i may be assigned to switch k. In one example, when switch i may be assigned to switch k, zᵢₖ=1, and when switch i may not be assigned to switch k, zᵢₖ=0. zᵢₖ′ may be no smaller than 0 and no more than 1, representing how likely how likely switch i is assigned to controller k. Iᵢₖ may represent whether distance between switch I and controller k, denoted as Distance (i, k), may be no more than a pre-configured distance value. When Distance (i, k) may be no more than the pre-configured distance value, Iᵢₖ=1, and when Distance (i, k) may not be no more than the pre-configured distance value, Iᵢₖ=0. Based on yₖ, zᵢₖ and Iᵢₖ, the foregoing requirements 1-4 may be represented as follows equations:

Requirement 1:

$${\sum }_{k ∈ V} {z}_{ik} {I}_{ik} = 1$$

∀iεV;

Requirement 2: Iᵢₖ=1;

Requirement 3: yₖ=1−Π_{eεV}(1−zᵢₖIᵢₖ) and yₖ≧zᵢₖIᵢₖ ∀iεV, kεV.

Requirement 4:

$${\sum }_{i ∈ V} {σ}_{i} {z}_{ik} {I}_{ik} < {μ}_{C}^{k}$$

∀kεK⊂V

Requirements 1-4 may be stored in constraint sub-module, σᵢ may represent a mean speed rate value of a control flow brought by switch i, μ_{C}^{k} may represent serving capability the controller k.

In order to obtain identify possible values of the selection likelihood and the assignment likelihoods of each switch, yₖ and zᵢₖ in the forgoing equations may be replaced by yₖ′ and zᵢₖ′.

The selection likelihood of each switch may be assigned to one of a range or a set of possible values. For example, referring to FIG. 1B, the selection likelihood of switch 106A may have a plurality of possible values, the selection likelihood of switch 106B may have a plurality of possible values, the selection likelihood of switch 106C may have a plurality of possible values, the selection likelihood of switch 106D may have a plurality of possible values, and so on.

The assignment likelihoods of each switch may have a plurality of possible values. For example, referring to FIG. 1B, the assignment likelihoods of switch 106A having a plurality of possible values may mean that the likelihood of assigning switch 106B to a controller located with switch 106A may have a plurality of possible values, the likelihood of assigning switch 106C to a controller located with switch 106A may have a plurality of possible values, the likelihood of assigning switch 106D to a controller located with switch 106A may have a plurality of possible values, the likelihood of assigning switch 106E to a controller located with switch 106A may have a plurality of possible values, the likelihood of assigning switch 106F to a controller located with switch 106A may have a plurality of possible values, the likelihood of assigning switch 206G to a controller located with switch 106A may have a plurality of possible values, the likelihood of assigning switch 106H to a controller located with switch 106A may have a plurality of possible values.

The possible values of the selection likelihood of each switch, such as switch 106A of FIG. 1B, may be associated with the possible values of the assignment likelihoods of the same switch, such as switch 106A. For example, when the selection likelihood of switch 106A is set to a particular value, the possible values of the assignment likelihoods of switch 106A may be constrained to a particular set of values associated with this particular value. Different values of the selection likelihood of switch 106A may be associated with different sets of possible values for the assignment likelihood of switch 106A.

Step 324 may be performed by possible values identification sub-module 134B.

At step 326, process 320 may compare values of an objective measure of the switches among the possible values of the selection likelihood. An objective measure may provide an indication or a value of number of the controllers required for the SDN, for example, based on values assigned to selection likelihoods and/or assignment likelihoods of the switches of in the SDN.

In one embodiment, when each switch can have n possible values of the selection likelihood, the objective measure may have n values of the objective measure. Process 320 compare the n values of the objective measure with each other. In one example, each switch may have 2 possible values of the selection likelihood in an SDN network. For example, switch 106A may have a selection value a1, switch 106B may have a selection value b1, switch 106C may have a selection value c1, switch 106D may have a selection value d1, switch 106E may have a selection value e1, switch 106F may have a selection value f1, switch 106G may have a selection value g1 and switch 106H may have a selection value h1, where a selection value means a value of the selection likelihood. It further means that switch 106A may have a selection value a2, switch 106B may have a selection value b2, switch 106C may have a selection value c2, switch 106D may have a selection value d2, switch 106E may have a selection value e2, switch 106F may have a selection value f2, switch 106G may have a selection value g2 and switch 106H may have a selection value h2. The above 8 selection values a1 to g1 satisfy each or any combination of the above requirements 1 to 4. The above 8 selection values a2 to g2 also satisfy each or any combination of the above requirements 1 to 4. A placement server performing process 320 may obtain a first value of the objective measure based on the above 8 selection values A1 to G1. The first value may indicate number of controllers to be deployed in the SDN. The placement server based on process 320 may also obtain a second value of the objective measure based on the above 8 selection values a2 to g2. The second value also indicates number of controllers to be deployed in the SDN.

Step 326 may be performed by value comparison sub-module 134C.

At step 328, process 320 may select, based on the comparison, a set of values from the possible values of the selection likelihood and the assignment likelihoods of each switch. The selected set of values from the possible values of the selection likelihood of each switch may cause a value of the objective measure to satisfy a requirement or a constraint. The requirement may be based on the value of the objective measure. For example, the selected set of values may correspond to the smallest one among all values of the objective measure applied among the possible values of the selection likelihood. In one example, referring to FIG. 1B, if two separate sets of value assignment for the selection likelihoods and assignment likelihoods in network 100A correspond to a first value of the objective measure and a second value of the objective measure, the first value being the smallest one of all values considered via the objective measure, the selection values A1 to G1, which are associated with the first value of the objective measure, may be selected for network 100A.

After the set of values from the possible values of the selection likelihood of each switch are selected, the set of values from the possible values of the assignment likelihoods of each switch may be selected based on the selected values from the possible values of the selection likelihood of each switch and the allocation constraint. The selected set of values from the possible values of the selection likelihood of each switch and the selected set of values from the possible values of the assignment likelihoods of each switch may be subject to the allocation constraint.

Step 328 may be performed by value selection sub-module 134D.

At step 330, process 320 may round (or perform rounding operations for) the set of values selected to integer values respectively in a randomized rounding manner. The integer values may indicate where each controller should be located among the separate locations of the switches. Each integer value may also indicate which of the controllers each switch should be assigned to.

In one embodiment, process 320 may perform the rounding operations with an ending condition or termination condition. The ending condition may be employed for determining when the rounding operations should stop or end. The ending condition may be based on number of the switches in the network system. The rounding operations may result in generating indicators for the switches. For example, the indicators may include one or more 0 and one or more 1. An indicator may correspond to a selection likelihood of a switch or a likelihood of assigning a switch to a controller located in or with another switch.

For example, when the selection likelihood of a switch is 0, it may mean that no controller may be located with the switch, and when the selection likelihood of the switch is 1, it may mean that a controller may be located with the switch. When the likelihood of assigning a switch, such as switch 106A of FIG. 1B, to a controller located with another switch, such as switch 106B of FIG. 1B, is 0, it may mean that the switch, such as switch 106A, may not be assigned to the controller located with the another switch, such as switch 106B. When the likelihood of assigning a switch, such as switch 106A, to a controller located with another switch, such as switch 106B, is 1, it may mean that the switch, such as switch 106A, may be assigned to the controller located with the another switch, such as switch 106B.

In one embodiment, process 320 may perform rounding operations for rounding the set of values selected to integer values according to an algorithm shown as foregoing table 1. The placement of controllers may be formulated as follows:

| | |
|---|---|
| Find | yₖ,zᵢₖ ∀ i ∈ V,k ∈ V |
| Minimize | C = Σ_{k∈V} yₖ |
| Subject to | requirements 1, 3 and 4 |

What is formulated above may be input of the algorithm in table 1. Algorithm in table 1 may work as follows. First, relaxed linear programming may be solved to get an optimal fractional solution (OPT), denoted as yₖ′, zᵢₖ′, ∀ᵢεV, kεV. Next, these fractional solutions are rounded to integer values, denoted as y̅ₖ, z̅ᵢₖ, ∀ᵢεV, kεV, via a randomized rounding procedure. The rounding procedure consists of two steps: (i) set all z̅ᵢₖ to zero; then, (ii) let z̅ᵢₖ=1 with probability zᵢₖ′ and execute this step for log(n)+2 times, where n is the number of switches in the network. Step (ii) yields an integer solution (C̅; y̅ₖ, z̅ᵢₖ), where C̅=Σ_{kεV}y̅ₖ, Step (ii) is repeated until each controller has finite queue delay and the minimum number of required controllers C̅ satisfies the condition that C̅≦αC′, where C′=Σ_{kεV}yₖ′ and α is a constant provided in line 9 of the algorithm in table 1.

Step 330 may be performed by rounding sub-module 134E.

At step 332, process 320 may allocate, based on the integer values generated via the rounding operations, the controllers in the SDN. The integer values can indicate where each controller is located among the separate locations, and which of the controllers each switch should be assigned to. In some embodiments, SDN controllers may be dedicated hardware devices or hardware devices having both the function of SDN controller and other functions, such as determining topology or structure of SDN, allocation of SDN controllers in an SDN, etc. In an SDN, controllers may be hardware devices separated from switches in an SDN. An SDN may include a plurality of switches and a plurality of controllers, where controllers may be less than switches. Each controller in the SDN may be coupled with several switches. For example, in network 100B, controller 108A may be coupled with switches 106A, 106B and 106D.

When a controller needs to be located with an identified switch, process 320 may send allocation instructions and/or assignment instructions to the identified switches/controllers according to the integer values generated. The instructions may be used to establish communicative connection between the identified switch and a controller to be located with the identified switch. The controller may only receive control messages from this communicative connection. For example, when controller 108A is allocated to switch 106B, process 320 may send allocation instructions and/or assignment instructions to controller 108A. With the instructions, controller 108A may establish connection with switch 106B. Controller 108A may receive control messages through the connection from 106B. When switch 106A or 106D sends control messages to controller 108A, the control messages need to be sent to switch 106B and then sent to controller 108A via the connection between controller 108A and switch 106B.

In one embodiment, process 320 may generate a user interface presenting the result of allocation/assignment decisions based on the integer values. Process 320 may send a message to designated targets with the allocation/assignment results. In one embodiment, process 320 may monitor whether corresponding allocation/assignment have been complemented in the SDN.

Step 332 may be performed by allocation module 132.

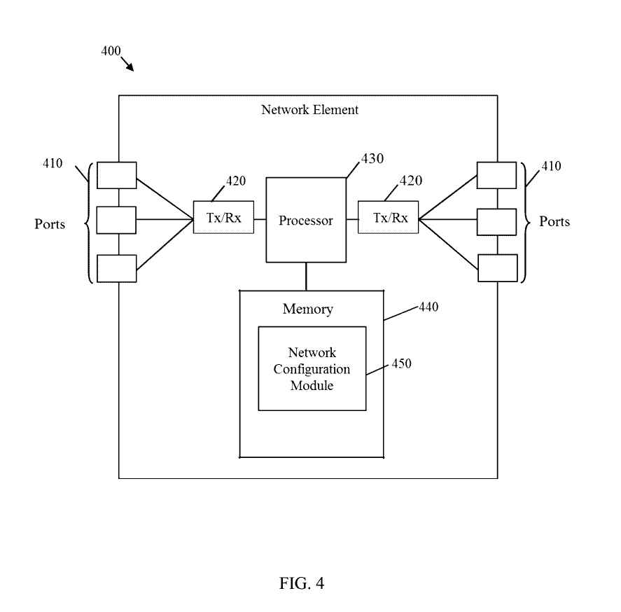

FIG. 4 is a schematic diagram of a network element 400 for determining optimal controller placement and/or control traffic forwarding among a plurality of links at the same time. The network element 400 may be suitable for implementing the disclosed embodiments. Network element 400 comprises ports 410, transceiver units (Tx/Rx) 420, a processor 430, and a memory 440 comprising a network configuration module 450. Ports 410 are coupled to Tx/Rx 420, which may be transmitters, receivers, or combinations thereof. The Tx/Rx 420 may transmit and receive data via the ports 410. Processor 430 is configured to process data. Memory 440 is configured to store data and instructions for implementing embodiments described herein. The network element 400 may also comprise electrical-to-optical (EO) components and optical-to-electrical (OE) components coupled to the ports 410 and Tx/Rx 420 for receiving and transmitting electrical signals and optical signals.

The processor 430 may be implemented by hardware and software. The processor 430 may be implemented as one or more central processing unit (CPU) chips, logic units, cores (e.g., as a multi-core processor), field-programmable gate arrays (FPGAs), application specific integrated circuits (ASICs), and digital signal processors (DSPs). The processor 430 is in communication with the ports 410, Tx/Rx 420, and memory 440.

The memory 440 comprises one or more of disks, tape drives, and solid-state drives and may be used as an over-flow data storage device, to store programs when such programs are selected for execution, and to store instructions and data that are read during program execution. The memory 440 may be volatile and non-volatile and may be read-only memory (ROM), random-access memory (RAM), ternary content-addressable memory (TCAM), and static random-access memory (SRAM). Network configuration module 450 is implemented by processor 430 to execute the instructions for implementing various embodiments previously discussed.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is generally conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially

While several embodiments have been provided in the represent disclosure, it should be understood that the disclosed systems and methods might be embodied in many other specific forms without departing from the spirit or scope of the represent disclosure. The representing examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the represent disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

1. A method for network configuration, comprising:
providing representation of a software defined network (SDN) comprising a plurality of switches located in separate locations, wherein each switch has a selection likelihood and one or more assignment likelihoods, the selection likelihood to indicate how likely a controller is located with the switch, each assignment likelihood of the switch to indicate how likely a separate one of the switches is assigned to a controller located with the switch;
identifying possible values of the selection likelihood and the assignment likelihoods of each switch subject to allocation constraint imposed on one or more controllers of the SDN;
comparing values of an objective measure of the switches among the possible values of the selection likelihood, wherein the objective measure indicates number of the controllers for the SDN;
selecting, based on the comparison, a set of values from the possible values of the selection likelihood and the assignment likelihoods of each switch;
rounding the set of values selected to integer values respectively in a randomized rounding manner, wherein the integer values indicate where each controller is located among the separate locations, and wherein the integer values indicate which of the controllers each switch is assigned to; and
allocating, based on the integer values, the controllers in the SDN.

2. The method of claim 1, wherein the allocation constraint indicates that each switch is assigned to no more than one controller in the SDN.

3. The method of claim 1, wherein the allocation constraint indicates that a distance between one of the switches and one of the controllers assigned to the one switch is no more than a preconfigured value.

4. The method of claim 1, wherein the allocation constraint indicates that an assignment likelihood of one of switches is no more than a selection likelihood of the one switch.

5. The method of claim 1, wherein one of the controllers is located with one of the switches, wherein one or more of the switches are assigned to the one controller, the one controller having a processing capacity, the one or more switches to generate an amount of control traffic, and wherein the allocation constraint indicates that the amount of the control traffic is within the processing capacity of the one controller.

6. The method of claim 1, wherein a value of the objective measure of the switches based on the selected set of values comprises a minimum value among the values of the objective measure of the switches among the possible values of the selection likelihood and the assignment likelihoods of each switch.

7. The method of claim 1, wherein the selected set of values specify one value for the selection likelihood of each switch.

8. The method of claim 7, wherein each pair of a first switch and a second switch of the switches is associated with an assignment likelihood of the first switch for assigning the second switch to a controller located with the first switch and wherein the selected set of values specify one value for the assignment likelihood associated with each pair of the switches.

9. The method of claim 1, wherein the set of values selected are rounded to integer values respectively based on number of the switches in the SDN.

10. A device, comprising:
a non-transitory memory storage comprising instructions; and
one or more processors coupled to the memory that execute the instructions to:
identify possible values of selection likelihood and assignment likelihoods of each switch in a software defined network (SDN) subject to allocation constraint imposed on one or more controllers of the SDN, where each switch has a selection likelihood and one or more assignment likelihoods, the selection likelihood to indicate how likely a controller is located with the switch, each assignment likelihood of the switch to indicate how likely a separate one of the switches is assigned to a controller located with the switch;
compare values of an objective measure of the switches among the possible values of the selection likelihood, wherein the objective measure indicates number of the controllers for the SDN;
select, based on the comparison, a set of values from the possible values of the selection likelihood and the assignment likelihoods of each switch;
round the set of values selected to integer values respectively in a randomized rounding manner, wherein the integer values indicate where each controller is located among the separate locations, and wherein the integer values indicate which of the controllers each switch is assigned to; and
allocate, based on the integer values, the controllers in the SDN.

11. The device of claim 10, wherein the allocation constraint indicates that each switch is assigned to no more than one controller in the SDN.

12. The device of claim 10, wherein the allocation constraint indicates that a distance between one of the switches and one of the controllers assigned to the one switch is no more than a preconfigured value.

13. The device of claim 10, wherein the allocation constraint indicates that an assignment likelihood of one of switches is no more than a selection likelihood of the one switch.

14. The device of claim 10, wherein one of the controllers is located with one of the switches, wherein one or more of the switches are assigned to the one controller, the one controller having a processing capacity, the one or more switches to generate an amount of control traffic, and wherein the allocation constraint indicates that the amount of the control traffic is within the processing capacity of the one controller.

15. The device of claim 10, wherein a value of the objective measure of the switches based on the selected set of values comprises a minimum value among the values of the objective measure of the switches among the possible values of the selection likelihood and the assignment likelihoods of each switch.

16. The device of claim 10, wherein the selected set of values specify one value for the selection likelihood of each switch.

17. The device of claim 16, wherein each pair of a first switch and a second switch of the switches is associated with an assignment likelihood of the first switch for assigning the second switch to a controller located with the first switch and wherein the selected set of values specify one value for the assignment likelihood associated with each pair of the switches.

18. The device of claim 10, wherein the set of values selected are rounded to integer values respectively based on number of the switches in the SDN.

19. A non-transitory computer-readable medium storing computer instructions, that when executed by one or more processors, perform the steps of:
identifying possible values of selection likelihood and assignment likelihoods of each switch in a software defined network (SDN) subject to allocation constraint imposed on one or more controllers of the SDN, where each switch has a selection likelihood and one or more assignment likelihoods, the selection likelihood to indicate how likely a controller is located with the switch, each assignment likelihood of the switch to indicate how likely a separate one of the switches is assigned to a controller located with the switch;
comparing values of an objective measure of the switches among the possible values of the selection likelihood, wherein the objective measure indicates number of the controllers for the SDN;
selecting, based on the comparison, a set of values from the possible values of the selection likelihood and the assignment likelihoods of each switch;
rounding the set of values selected to integer values respectively in a randomized rounding manner, wherein the integer values indicate where each controller is located among the separate locations, and wherein the integer values indicate which of the controllers each switch is assigned to; and
allocating, based on the integer values, the controllers in the SDN.

20. The computer-readable medium of claim 19, wherein a value of the objective measure of the switches based on the selected set of values comprises a minimum value among the values of the objective measure of the switches among the possible values of the selection likelihood and the assignment likelihoods of each switch.
